(19) United States
(12) Patent Application Publication
(10) Pub. No.: US 2025/0392882 A1
(43) Pub. Date: Dec. 25, 2025

(54) SYSTEM AND METHOD FOR VISUAL ENABLEMENT OF A REAL-TIME LOCATION SYSTEM

(71) Applicant: HANWHA VISION CO., LTD., Seongnam-si (KR)

(72) Inventor: Jeffrey M. Sweeney, Carlsbad, CA (US)

(73) Assignee: HANWHA VISION CO., LTD., Seongnam-si (KR)

(21) Appl. No.: 18/752,789

(22) Filed: Jun. 25, 2024

(51) Int. Cl. H04W 4/029; G06V 20/52; G08B 25/01; H04W 4/33

(52) U.S. Cl. CPC H04W 4/029; G06V 20/52; G08B 25/016; H04W 4/33

(57) ABSTRACT

Disclosed is a method and apparatus for performing, by a management platform operatively connected to both a video surveillance platform and a positioning platform via network connectivity, at least one among image processing and video analytics on obtained images or video related to a detected asset tag to provide user awareness related to a location or movement of the asset tag in a defined environment.

### RELATED ART

The present disclosure broadly relates to image processing that involves recognition of people or objects in images of a coverage area captured by one or more cameras, performing image data processing thereof and performing management of location-based events.

### BACKGROUND

An example of the related or background art can be found in US 2019/0253747 A1 entitled: “Systems and methods for integrating and delivering objects of interest in video.” Its abstract states the following: “Systems and methods are described for providing clear areas related to objects of interest in a video display. In accordance with an embodiment, a method includes capturing, with a camera, a video frame of a scene; determining a camera orientation and camera location of the camera capturing the video; determining a location of an object of interest; mapping the location of the object of interest to a location on the video frame; determining an object-of-interest area based on the location of the object of interest on the video frame; determining a clear area on the video frame; transmitting a location of the clear area to a client device; and displaying the video frame and metadata associated with the object of interest in the clear area.”

Another example of the related or background art can be found in U.S. Pat. No. 8,477,046 B2 entitled: “Sports telemetry system for collecting performance metrics and data.” Its abstract states the following: “Systems and methods for collecting sports data include measuring, at one or more sensor modules mounted, affixed, or embedded on at least one sports participant, data corresponding to identification, movement, position, or condition of the at least one sports participant; measuring, at one or more sensor modules mounted, affixed, or embedded in a sports object, data corresponding to identification, movement, position, or condition of the sports object; and broadcasting, from one or more telemetry modules mounted, affixed, or embedded on the sports object or on the at least one sports participant, signals carrying the data corresponding to identification, movement, position, or condition of the sports object or signals carrying the data corresponding to identification, movement, position, or condition of the at least one sports participant. In one embodiment, predictive action cameras are controlled to aim at an anticipated or predicted position of a sports participant or sports object.”

### BRIEF SUMMARY

However, depending upon where and how such systems and methods are implemented, certain improvements and/or enhancements thereto may be needed. Thus, to address such needs, according to at least some embodiments described herein, location-based event or alarm management is performed by combining certain aspects of Real-Time Location System (RTLS) technology with certain aspects of video surveillance technology.

### BRIEF DESCRIPTION OF DRAWINGS

The accompanying figures, where like reference numerals refer to identical or functionally similar elements throughout the separate views and which together with the detailed description below are incorporated in and form part of the specification, serve to further illustrate various embodiments and to explain certain principles and effects in accordance with the present disclosure.

FIG. 1 depicts a conceptual diagram showing the relationships between particular exemplary elements that are applicable to one or more embodiments according to the present disclosure.

FIG. 2 depicts exemplary implementations for RTLS only and video only situations according to the related art.

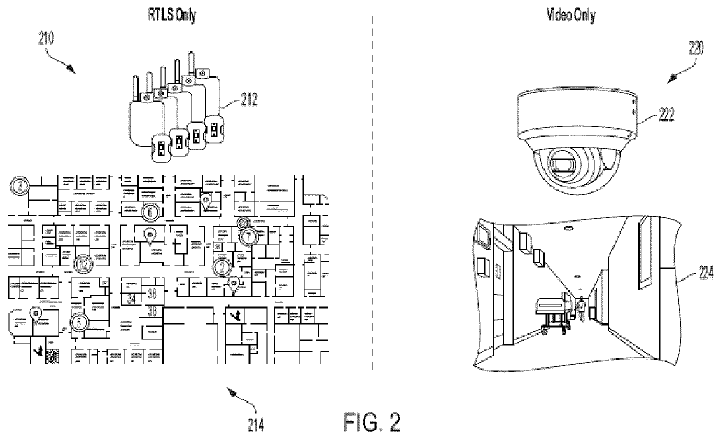

FIG. 3 depicts a conceptual solution according to an embodiment of the present disclosure.

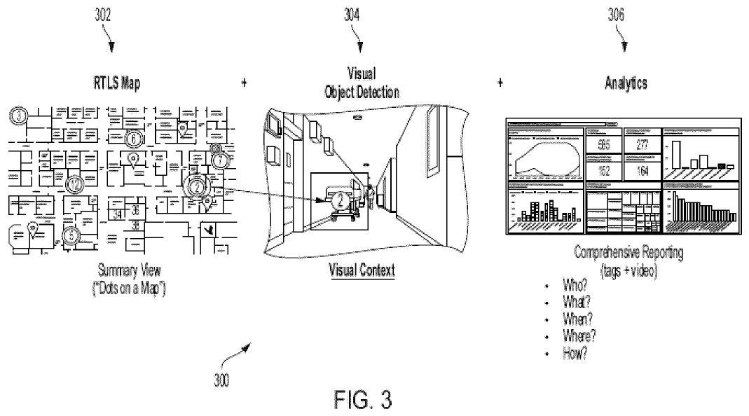

FIG. 4 depicts another conceptual solution according to another embodiment of the present disclosure.

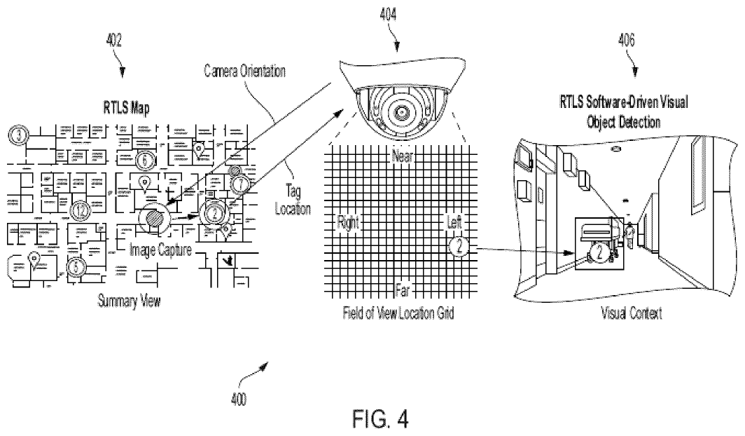

FIG. 5 shows an exemplary display screen shot for a virtual healthcare related implementation according to one or more embodiments described herein.

FIG. 6 shows an exemplary hardware set up according to one or more embodiments described herein.

FIG. 7 shows an exemplary display screen shot for another virtual healthcare related implementation according to one or more embodiments described herein.

FIG. 8 shows an exemplary structural diagram of a surveillance camera according to one or more embodiments described herein.

FIG. 9 shows a flowchart of an exemplary method according to one or more embodiments described herein.

Those skilled in the art will appreciate that some elements in the figures are illustrated for simplicity and clarity and have not necessarily been drawn to scale. The dimensions of some elements in the figures may be exaggerated relative to other elements to help to improve understanding of embodiments of the present disclosure.

### DETAILED DESCRIPTION

Before explaining the embodiments in detail, it should be understood that the inventive features described herein are not limited in its application to the details in the construction or arrangement of components or method steps set forth in the following description or illustrated in the drawings. The inventive features are capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings, unless specified as such.

The following disclosure is presented to enable a person skilled in the art to make and use embodiments being described. Various modifications to the embodiments will be readily apparent to those skilled in the art, and the generic principles herein can be applied to other embodiments and applications. Thus, the inventive features are not intended to be limited to the embodiments shown, but are to be accorded the widest scope consistent with the principles and features disclosed herein. The following detailed description is to be read with reference to the figures that depict selected embodiments and are not intended to limit the scope thereof. Skilled artisans will recognize the examples provided herein have many useful alternatives that still fall within the scope of the embodiments.

The present inventor specifically recognized certain shortcomings in the related art and/or the background art, which led to in-depth research and development activities for achieving the specific technical improvements and/or enhancements with respect to video surveillance implementations to be described hereafter.

A position or location tracking system, such as a Real-Time Location System (RTLS), can estimate the location of a tag (e.g., an asset tag, a tagged asset, a personnel badge, identifier, wireless device, etc.) that is on an object or carried by, attached to or worn by a person who enters, exits and moves about in rooms, floors and buildings. Typically, such tracking systems employ radio-frequency (RF) signals based on Wi-Fi, Bluetooth, or some other wireless technology. Access Points, beacons, sensors, etc. can measure and use the received signal strength and/or angle-of arrival from the tag for estimating the distance thereto and algorithms can be used to estimate the location thereof. Such location estimates are acceptable and used in many industrial environments, including those for video surveillance.

Video surveillance cameras provide visual information about insights for a coverage area(s). RTLS provides location information for assets (i.e., people or objects) located within a coverage area. The combination of these two technologies creates higher value in the form of remote “visual enablement” of tags (i.e., tagged assets) within an RTLS network providing “context” to the user. Examples of such context may include: What is near, around, on, under or adjacent to the asset being tracked? Who moved the asset (object)? How was the asset moved (object)? Does the asset tag (i.e. badge) correspond with the profile of the assigned user (person)?

At least some basic concepts and/or broad features related to the inventive embodiments described herein can be stated as follows:

### Technical Problems to be Solved

Combining an RTLS platform with a Video Surveillance platform to allow an end user to “visualize” the real or perceived location of a tagged asset through the use of bounding boxes or other such visual identifier;

Mapping the field of view for each and every camera in a network location in a method that is recognizable and actionable to both the RTLS platform and the Cameras operating as part of the Video Surveillance platform;

Forwarding the location of a tagged asset requiring visual identification to the correct camera(s) with the network;

Correctly orientate the camera and/or apply a bounding box, or equivalent, to the real or perceived location of the tagged asset-digital orientation-which may or may not include a clear visual representation of the tagged asset if, in fact, the tagged asset is located inside of a box, purse, or other such container or is otherwise hidden from view.

Some Technical Features That Are Novel and/or Inventive

Mapping the field of view of each and every camera within a network with location identifiers (e.g. in a grid format) with a granularity approximately equivalent to the location accuracy of the RTLS platform;

Routing the location of an asset tag to the correct camera(s) within a network based on a lookup (or some other type of information matching scheme) of all available field of views (as captured per granular coordinates of each);

Triggering a visual identifier in the form or a bounding box (or some equivalent) of a real or perceived location from one or more cameras with the network based on the location coordinates of the tagged asset as provided by the RTLS platform (Note: the expected object may or may not be visible since it may be hidden).

In terms of the “how”, the orientation of the camera from an asset tag can be achieved in three (3) ways:

As Option #1, a wireless radio/scanner is added to the camera hardware resulting in the newly modified camera installation becoming both a camera and an access point. Alternatively, an access point could be installed in close proximity to a camera.

For Option #2, the field of view for each and every camera in a network is mapped out in a “grid” fashion. The location identifier of an asset tag is bumped up against a lookup table listing the location identifiers of view of every camera in the network. The incremental grid locations for the field of view of each camera can be further associated as pre-set focus points. If and when there is a match between the location identifier of the tag and a field of view for a specific camera, the system would then orientate the correct camera within the network to the correct/approximate perceived (non-visible) or real (visible) location.

Option #3 is similar to the second option, however, instead of leveraging the pre-set functionality in the context of a “virtual grid” to orientate the camera, the location identifier of the tag would be translated into orientation coordinates to position the camera. The subtle difference between Option #2 and Option #3 is that Option #3 would be more “granular” and precise since it would involve actually orientating the position of the camera with the actual location identifier of the asset tag as opposed to, in essence, saying that the asset tag should be within the boundaries of a particular virtual grid.

### Exemplary Effects of the Invention

The ability to provide “visual context” and other relevant information for a tagged asset: Is something next to, on top of, or near the tagged asset? Is it currently being used? Who moved the tagged asset? What other objects or people are near the tagged asset?

Accordingly, some basic concepts and/or broad features related to the inventive embodiments can be expressed as follows:

At a particular facility, such as a hospital, a plurality of “tags” (i.e., asset tags or some other detectable tracker devices) can be placed at or near assets (i.e. people or objects). With respect to a video surveillance platform having multiple network-connected cameras and/or other sensing devices at the particular facility, information regarding a field of view for each camera can be mapped out into a grid-like format (or into some other coordinate system) such that labels (or some other visual indication) can be placed therein or associated thereto.

A network of receivers, sensors, etc. that can detect the tags are strategically located throughout the facility as well. Each tag has an “identifier” (or some other unique characteristic associated thereto) that is detectable by the receivers upon satisfaction of certain events, conditions or via control commands. Such identifier can be compared with previously stored or known information (e.g., entries in a look-up table, database, memory, etc.) in order to identify or obtain an estimated location of the tag.

Then, with respect to such tag location estimation, one or more cameras at or near the region related to the “identifier/information comparison” can be operated, positioned and/or activated to capture images or video thereof. Imaging techniques and/or video analytics are used for performing “bounding box” processing (or some other spatial indication technique) to the captured images or video to show the user or viewer where the tag is actually located, even if the tag is not in plain view. Namely, even if the tag is visually obstructed in some manner (e.g., intentionally hidden, unintentionally blocked, placed in a container, etc.), the techniques in these inventive embodiments can provide the user or viewer with useful or meaningful “visual context” that allows for visual confirmation, situational context, and real-time and/or historical insights regarding the location and/or movement of asset tags within and around a defined environment.

Here, it should be noted that at least some features in one or more the embodiments described herein were not simply developed due to mere reasonable expectation of success based on routine experimentation or routine testing. However, it should be noted that patentability shall not be negated by the manner in which the invention was made and thus, so-called “routine experimentation” in and of itself does not necessarily preclude patentability.

At least some embodiments herein pertain to customizable analytics zones and event-based alarms, which are supported by edge-based video and audio analytics. Doing so can help in reducing the frequency of false alarms while increasing the efficiency of forensic review. Some or all of the following features may be implemented:

Face detection: Identifies key facial features and issues alerts when a face is present;

Virtual line crossing detection: Triggers an alarm when objects are detected crossing a pre-defined virtual line or perimeter;

Loitering detection: Triggers an event when an object enters and rests in a designated virtual zone;

Intrusion detection: Triggers an event when movement is detected in a designated virtual zone;

Enter/exit detection: Detection of objects entering or exiting a designated area;

Appear/disappear detection: Detects the appearance or disappearance of an item in a designated virtual zone;

Audio analytics: Detects and identifies the sound of explosions, gunshots, screams, and breaking glass.

In addition, at least some features in at least some embodiments can be integrated with certain aspects of so-called “context-awareness” techniques or technology. For some technical reference, “context-aware computing” may refer to performing some processing that changes its content on its own based on certain types of information or data, such as measured sensor data. An example would be how time and position change with respect to a smartphone based on where the user carrying that smartphone is physically located. Put in other terms, context-aware computing is a style of computing in which situational and environmental information about people, places and things is used to anticipate immediate needs and proactively offer enriched, situation-aware and usable content, functions and experiences.

In a similar manner, such “context-awareness” techniques can be applied to the embodiments herein related to a video surveillance platform having RTLS integrated thereto.

The present inventor recognized that the combination of at least these two technologies, namely, an RTLS platform with a Video Surveillance platform (and potentially together with context-awareness processing) could be useful in the healthcare industry.

According to the American Hospital Association, there are 6,129 hospitals in the U.S. and roughly 25% to 30% use some form of RTLS/asset tracking solution. Furthermore, according to the research firm Markets & Markets, the global RTLS market for healthcare is forecasted to grow from $2B in 2023 to $5.8B by 2028 (23.5% CAGR). Additionally, approximately 3M of the 5M registered nurses in the U.S. (60%) work in hospitals resulting in, on average, approximately 500 nurses per hospital location in the U.S. According to the U.S. Bureau of Labor Statistics, healthcare workers are five times more likely to experience workplace violence compared to workers in other industries.

Workplace violence and safety for staff and patients are key issues within the healthcare market segment. According to the U.S. Bureau of Labor Statistics, healthcare workers are five times more likely to experience workplace violence compared to workers in other industries. An embodiment of this invention is to leverage installed video cameras and an installed RTLS platform to create an enhanced “staff duress” solution to improve the safety of medical staff in a hospital setting.

According to the embodiments described herein, such staff duress solution could include the following systems and subsystems:

Legacy RTLS platform, which can include RTLS-enabled mobile devices issued to staff for safety purposes;

Legacy “context-awareness” techniques, which can include installed cameras in the patient rooms and a Nurse Station monitor; and

Staff Duress Software, which provides a linkage between legacy RTLS platform and the “context-awareness” platform, a location-based activation of installed “context-awareness” cameras, and a location-based alarm routing to the nearest Nurse Station.

At least some embodiments described herein relate to an RTLS system-driven dynamic position identification solution for visual object detection and capture. Such technology provides “visual context” to certain RTLS solutions resulting in the creation of a more compelling user experience compared to simply viewing “dots on a map” or the location of assets on a list. In addition to adding value to the tracking of objects, an enhanced personal security solution is also disclosed herein.

In more detail, some examples of one or more typical use cases for the Staff Duress solution may be as follows:

A nurse wearing an RTLS-enabled badge (or equivalent) with an emergency button signals an emergency event while in a patient's room. The alarm and location are received by the RTLS platform and transmitted to the nearest Nurse Station to the alarm event. The Staff Duress software can process the alarm event at the nurse station including remotely activating the camera(s) in the patient's room. Staff located at the Nurse Station would manage the response to the “call for assistance,” which may include: an Alarm event, a Staff member initiating the alarm, a Location of the alarm event, and a Streaming video to allow the nurse station to assess the situation and organize an appropriate response.

Hereafter, some issues related to Users/Personas who may be involved with in these use cases will be described hereafter.

### (1) Nurse/Medical Staff

“I want to feel safe at work and be able to quickly, easily, and discreetly initiate a ‘call for help’ if needed”.

“I want to be able to provide my patients with a safe environment”.

“I want my colleagues to be able to quickly respond quickly to my remote ‘call for help’”.

“I want the response to be appropriate for the situation.”

### (2) Nurse Station

“I want my colleagues to feel safe and be safe while checking on patients.”

“I want to see live video to be able to provide a quick and appropriate response if and when I receive an alert.”

“I want to know the name of my colleague who initiated the alarm.”

“I want to know the exact location of the origination of the alarm.”

“I want the know the name of the patient, the attending physician, and their illness/injury.”

“I want to know if and how many alarm events have been associated with this patient during their hospital stay.”

“I want to be able to quickly summon and direct help in order to address the event.” (out of scope for the Staff Duress solution)

### (3) Patient

“I want to be discharged from the hospital as soon as possible. I don't want to have an injury or accident that would prolong my stay.”

“If I have an accident or jury in my patient room, I want the hospital staff to respond quickly and appropriately.”

“I want the medical staff to feel safe and enjoy their work. Happy and stress-free medical staff translates into a better environment for everyone including me as a patient.”

### (4) Security Personnel

“I want the nursing staff to be on the ‘frontlines’ for any events occurring in patient rooms.”

“I want an escalation protocol that allows the security team to intervene on the patient floor only in the event of a more severe incident.”

“I want detailed information-location and situational assessment-in the event that the security team is summoned to a patient room or floor.”

### (5) Management, Operations, and Legal

“I want to leverage the significant investments made in our RTLS and Epic platforms.”

“I want the nursing and medical staff to be the ‘first responders’ in the event of an incident in a patient's room.”

“I want detailed information and metrics regarding all alarm events for legal and managerial purposes.”

“I want to minimize response times and maximize the success resolution of alarm events. I want the staff to be safe and patients to be discharged on schedule.”

“I want the ability to record video in a patient's room the event of an incident for legal/liability purposes.”

In addition to the specific use cases cited above for healthcare, the combination of video cameras and RTLS has applications in many markets providing users with visual confirmation, situational context, and real-time and/or historical insights regarding the location and/or movement of asset tags within and around a defined environment.

### Description of One Possible Solution

The respective coverage areas of all installed cameras within a video surveillance network would be defined and mapped by specific location coordinates within the field of view for each camera. Location coordinates from the asset tags would then be routed to the appropriate camera(s), in any, located within the defined field of view relative to the location of the asset tag desired to be viewed by the user. This process could be configured to be initiated either manually or automatically (rules based) depending upon the needs of the operator of the system.

In the case of the Staff Duress embodiment disclosed previously, RTLS-enabled mobile devices issued to medical staff would be associated with identifiers such as device type and medical staff to whom the device has been issued. A similar exercise would occur for other asset tags associated with objects.

In the event an alarm is initiated from an RTLS-enabled mobile device AND the location is on a patient floor, the RTLS platform would be configured to forward the registered alarm event to the nearest Nurse Station operating a “context-awareness” system.

In the event an alarm is initiated from an RTLS-enabled mobile device AND the location is NOT on a patient floor, the RTLS platform may be configured to forward the registered alarm event to security personnel or other recipient for disposition.

This implies the need for “dynamic routing” based on the device type/categorization, location, location of nurse stations relevant to the origination of the alarm event, etc.

An alarm event received by the Nursing Station would compare the location of the event with patient records to determine the room number and patient(s) residing in that particular room. The system would be configured to automatically activate camera(s) in the patient room and populate the screen with relevant summary information such as the following:

The name of the medical staff who generated the alarm

The location of the alarm event (the room number)

The name of the patient(s)

The illness or injury of the patient(s)

A list of medications

The name of the patient's physician

Upon resolving the event, the Nurse Station would have the option to either deactivate the camera(s) or maintain the video feed if additional observation is deemed advisable or necessary.

The ability to categorize the event by type, time of occurrence, duration, and disposition for reporting purposes is also envisioned as a key value-add for the medical, legal, and managerial teams at the hospital.

In summary, the proposed Staff Duress feature would include establishing linkage between the legacy RTLS platform and the legacy “context-awareness” platform to allow for the transmission of alarm events meeting the following criteria:

RTLS device type (e.g. alarm device issued to staff)

RTLS assigned user

Location of the RTLS device when the alarm was initiated

Alarm routing logic (based on the location of the alarm event and proximity to the nearest or appropriate Nurse Station)

In addition, the proposed Staff Duress feature would be configured to activate the camera(s) in the room where the alarm event is occurring, populate the monitor at the Nurse Station with relevant patient and staff information to support the resolution of the event and, finally, be designed with post-event reporting capabilities.

As some further examples, certain features in at least some of the embodiments herein can be implemented into virtual healthcare related platform applications. Such may include, but are not limited to, virtual tele-sitting, virtual tele-consults, virtual tele-rounding, virtual nursing, virtual ADT (admissions, discharges and transfers), virtual ICU (intensive care unit) remote consultations and observations, virtual staff safety monitoring, and virtual high risk and behavioral health observations.

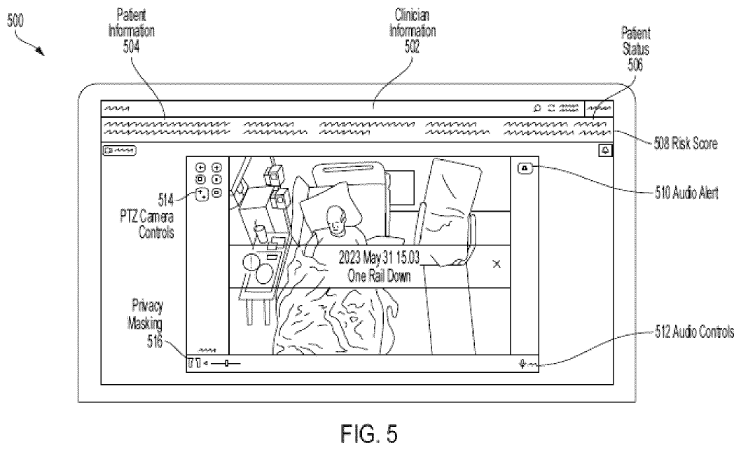

FIG. 5 shows an exemplary display screen shot for a virtual healthcare related implementation according to one or more embodiments described herein.

In this exemplary implementation 500, the screen shot on a display connected to a ceiling camera or the like is capturing one or more images of a patient in bed.

Various types of information can be conveniently shown to users via a single screen format. Clinician information 502 is shown at a top portion of the screen. Also, patient information 504 and patient status 506 can be provided at the top portion of the screen. In addition, a patient risk score 508, namely, a risk factor related to the patient status can also be shown.

Additionally, because an audio input/output means can be placed at or near the camera(s), sounds to and from the patient area can be output or input, and an audio alert icon 510 and audio controls 512 related thereto can be shown as well.

Furthermore, depending on what type of camera(s) is installed, camera control icons 514 can be displayed to allow user control thereof. Optionally, as patient privacy related information may be present, some sort of privacy masking 516 (or information hiding options) can be provided as well.

In such manner, a user-friendly virtual healthcare platform can be employed in accordance with one or more embodiments described herein.

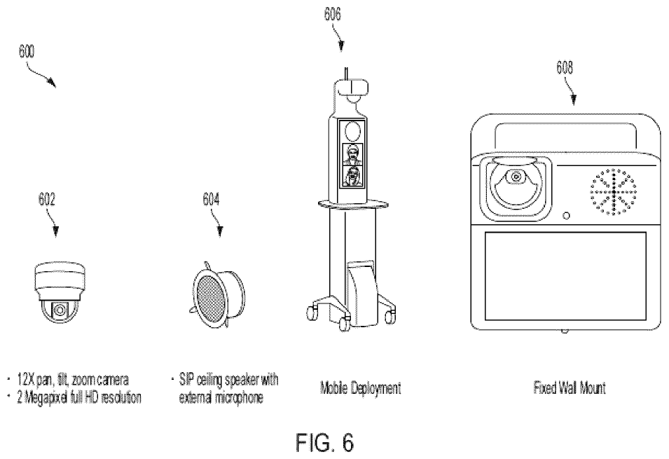

FIG. 6 shows an exemplary hardware set up according to one or more embodiments described herein.

In the overall set up 600, one or more cameras 602 can be strategically placed in a facility or area of interest. At or near each camera, ceiling speakers with microphones 604 (or other types of audio input/output means) can be employed. Depending upon where the features of the embodiments are implemented, a moveable platform 606, which can have a video interface, input/output means, sensors, etc., can be used to support mobile deployment. Furthermore, some sort of fixed wall mount interface 608, which may have a user interface with a display screen, audio input/output means, sensors, etc. can be employed.

In such manner, a user-friendly virtual healthcare platform can be employed in accordance with one or more embodiments described herein.

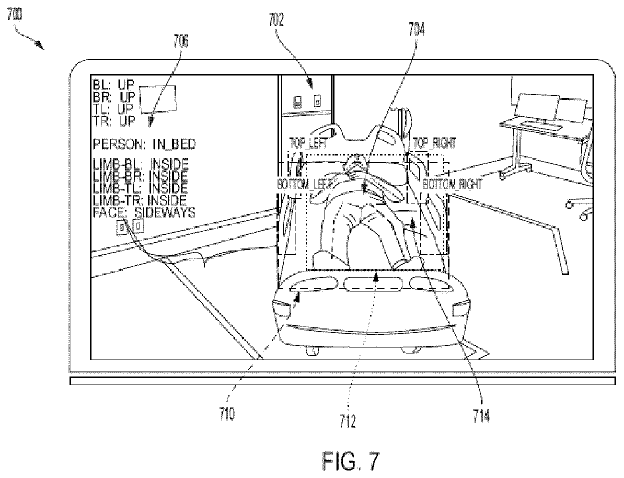

FIG. 7 shows an exemplary display screen shot for another virtual healthcare related implementation according to one or more embodiments described herein.

Here, a user interface screen 700 can provide various types of information. Due to one or more cameras installed in a patient room 702 or other hospital setting, images or video of a patient 704 in bed can be captured.

Certain type of information 706 can be provided on the screen. In the particular scenario being shown, the patient's prone position, including whether any arms or legs are within a permitted location within the patient bed boundaries can be detected and monitored.

In more detail, video analytics and image processing techniques are used to provide bounding box indications of the overall bed parameters 710, of the overall patient position 712, and of the position or orientation of each limb 714 of the patient.

In case one or more limbs of the patient move out of the desired region, the video analytics and image processing techniques can detect or anticipate this, and the appropriate health care worker can be notified of this situation.

As stated previously, the combination of video cameras and RTLS has applications in many markets in addition to healthcare to provide users with visual confirmation, situational context, and real-time and/or historical insights regarding the location and/or movement of asset tags within and around a defined environment.

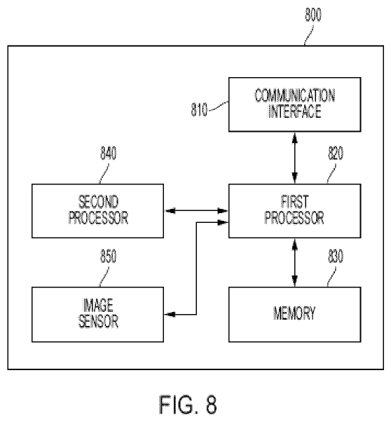

FIG. 8 is a schematic structural diagram of the surveillance camera 800, according to at least one embodiment.

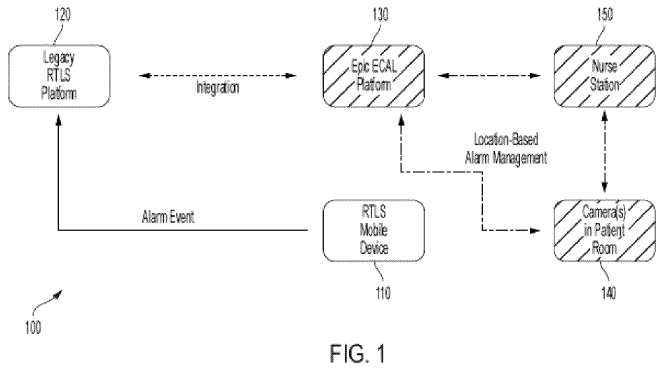

The surveillance camera 800 according to an embodiment may include a communication interface 810, a first processor 820, a memory 830, a second processor 840, and an image sensor 850. The surveillance camera 800 may represent a surveillance camera 140 in FIG. 1.

The communication interface 810 may be a device that transmit and receive an image or the like through a wired/wireless connection with another network device such as the image storage device. The communication interface may include any one or any combination of a digital modem, a radio frequency (RF) modem, a Wi-Fi chip, and related software and/or firmware.

The first processor 820 may be a device for controlling a series of processes of obtaining an image, segmenting the obtained image into units, and transmitting the units of the image to another network device such as the image storage device through the communication interface. Here, the term “processor” may refer to, for example, a data processing device that is embedded in a hardware component and has a physically structured circuit to perform a function expressed as a code or a command included in a program. Examples of the data processing device embedded in a hardware component may encompass processing devices such as a microprocessor, a central processing unit (CPU), a processor core, a multiprocessor, an application-specific integrated circuit (ASIC), a field programmable gate array (FPGA), and the like, but the present disclosure is not limited thereto.

The memory 830 performs a function of temporarily or permanently storing data processed by the surveillance camera 800. The memory may include magnetic storage media or flash storage media, but the scope of the present disclosure is not limited thereto. For example, the memory 830 may temporarily and/or permanently store an obtained image.

The second processor 840 may refer to a device that performs an operation under the control by the above-described first processor 820. In this case, the second processor 840 may be a device having a higher arithmetic capacity than the first processor 820 described above. For example, the second processor 840 may be configured as a graphics processing unit (GPU). However, this is an example, and the present disclosure is not limited thereto. In an embodiment, one second processor 840 may be provided or the second processor 840 may be provided in plurality.

The surveillance camera 800 according to an embodiment may not include the second processor 840.

The image sensor 850 may refer to various types of devices that convert an optical signal into an electrical signal. For example, the image sensor 850 may include a device that obtains ambient light and converts the same into an electrical signal, that is, in the form of an image, such as a charge-coupled device (CCD) or a complementary metal oxide semiconductor (CMOS).

The surveillance camera 800 according to an embodiment may not include the image sensor 850. In this case, despite the word “camera” in its name, the surveillance camera 800 may be a device that performs a function of transmitting an image stored in the memory 830 or an image received from an external device (not shown) to another device.

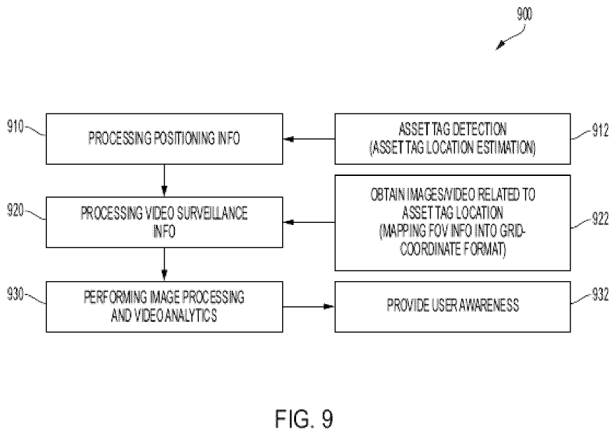

FIG. 9 shows a flowchart of an exemplary method according to one or more embodiments described herein.

In step 910, processing “positioning” information is performed.

Such may be from a positioning platform that detects at least one asset tag in a defined environment, the asset tag having an identifier that is compared with previously stored identification information in order to identify or obtain an estimated location of the asset tag (step 912).

In step 920, processing “video surveillance” information is performed.

Such may be from a video surveillance platform having a plurality of cameras that obtain images or video related to the detected asset tag based on the estimated location of the asset tag, whereby field of view information for at least one of the cameras is mapped into a grid-like or coordinate-based format that allows a visual indication to be associated thereto (step 922).

In step 930, performing, by a management platform operatively connected to both the video surveillance platform and the positioning platform via network connectivity, at least one among image processing and video analytics is performed.

Such is performed on the obtained images or video related to the detected asset tag to provide user awareness related to a location or movement of the asset tag in the defined environment (step 932).

Certain aspects of some or all of the embodiments described herein could also be expressed as follows:

First, the combination of a video surveillance platform and an RTLS platform can be configured to remotely and digitally orientate one or more cameras based on the location of an asset tag as determined by the RTLS platform.

Second, the combination can have the ability to dynamically route alarm events to the appropriate camera(s) and/or recipients based upon the location and defined field of view of each camera within a network relative to the location of the asset tag.

Third, the combination can have the ability to dynamically route requests to view specific tagged assets to the appropriate camera(s) and/or based upon the location and defined field of view of each camera within a network relative to the location of the asset tag.

Fourth, the combination can have the ability to define, assign and otherwise map specific coordinates of the field of view for the complete coverage area of each camera within a defined network. The ability for the specific coordinates of the field of view for the complete coverage area of each camera to interoperate with the location coordinates utilized in the operation of the RTLS platform.

Fifth, the combination can have the ability for the system to be configured to remotely orientate, either manually or automatically, the appropriate camera(s) within a network to provide video images of the location of an asset tag as determined by the RTLS platform. The ability of the same system to be configured to apply event-based logic (e.g., line crossing, time based, etc.) to initiate and/or otherwise capture video.

In addition, the following technologies can be applied to at least some features described in the embodiments herein.

AI (Artificial Intelligence, including Machine Learning, Large Language Models (LLMs), etc.) and tag tracking technologies (e.g., Real-Time Location System (RTLS) technology, “context-awareness” technology, Radio Frequency Identification (RFID), etc.) can be used together in numerous ways.

AI can be additionally used to further identify objects by their tag data. This can be used for a variety of purposes, such as tracking inventory, preventing theft, or controlling access to restricted areas.

AI can be used to further track or anticipate the movement of objects by their tag data. This can be used for a variety of purposes, such as optimizing supply chains, managing assets, or monitoring the environment.

AI can be used to predict the behavior of objects by analyzing their tag data. This can be used for a variety of purposes, such as predicting customer demand, identifying potential problems, or improving decision-making.

AI can be used to optimize processes by analyzing tag data. This can be used for a variety of purposes, such as improving efficiency, reducing costs, or improving quality.

At least some or all of the above can be implemented in at least one among the video surveillance subsystem (platform), the positioning subsystem (platform) and the management subsystem (platform) described herein.

WebRTC (Web Real-Time Communication) is an open-source technology that provides web browsers and mobile applications with real-time communication (RTC) features via application programming interfaces (APIs). Additionally, audio and video communication and streaming are provided to work within web pages by allowing direct peer-to-peer communication, eliminating the need to install plugins or download native applications.

It can be said that the purpose of WebRTC is to enable rich, high-quality RTC applications to be developed for the browser, mobile platforms, and IoT devices, and allow them all to communicate via a common set of protocols.

WebRTC technical specifications are published by the World Wide Web Consortium (W3C) and the Internet Engineering Task Force (IETF). W3C is developing ORTC (Object Real-Time Communications) for WebRTC.

Such WebRTC techniques are applicable to at least one among the video surveillance subsystem (platform), the positioning subsystem (platform) and the management subsystem (platform) described herein.

Some major components of WebRTC include certain JavaScript APIs which may be applicable to the embodiments herein:

For example, getUserMedia acquires the audio and video media data.

Also, RTCPeerConnection enables audio and video communication between peers, by performing signal processing, codec handling, peer-to-peer communication, security, and bandwidth management.

Additionally, RTCDataChannel allows bi-directional communication of data between peers. Such data is transported using Stream Control Transmission Protocol (SCTP) over Datagram Transmission Layer Security (DTLS). It uses the same API as WebSockets and has very low latency.

The WebRTC API also includes a statistics function that allows a web application to retrieve a set of statistics about WebRTC sessions.

The WebRTC API includes no provisions for signaling, that is discovering peers to connect to and determine how to establish connections among them. Applications use Interactive Connectivity Establishment for connections and are responsible for managing sessions, possibly relying on any of Session Initiation Protocol, Extensible Messaging and Presence Protocol (XMPP), Message Queuing Telemetry Transport, Matrix, or another protocol.

With respect to some exemplary technical standard related documents, RFC 7478 requires implementations to provide PCMA/PCMU (RFC 3551), Telephone Event as DTMF (RFC 4733), and Opus (RFC 6716) audio codecs as minimum capabilities. The PeerConnection, data channel and media capture browser APIs can be found in the W3C specification.

In addition, at least some features in one or more embodiments described herein are related to one or more technical standards, such as ISO/IEC 24730 and/or other standards related or relevant thereto, which continue to evolve with ongoing updates thereof. As such, at least some features described herein would be applicable to certain updates of one or more ISO/IEC 24730 based standards.

Various features of the embodiments herein can also be described as follows:

This disclosure provides a system comprising: a positioning subsystem having one or more components that obtain positioning information about one or more trackable devices in a defined environment, which is monitored by a video surveillance subsystem having one or more cameras that obtain video surveillance information; and a management subsystem that operatively cooperates with both the positioning subsystem and the video surveillance subsystem via network connectivity, and, based on the positioning information and the video surveillance information, provides users with improved awareness related to at least one among visual confirmation, situational context, real-time status and historical insights according to a location or movement of the trackable devices within and around the defined environment, when compared to a system that lacks the management subsystem cooperating with the positioning subsystem.

In the system above, the positioning subsystem supports at least one type of indoor positioning scheme that employs radio-frequency (RF) technologies and the one or more components are further configured to detect the trackable devices.

In the system above, the trackable devices comprise at least one among asset tags, tracking tags, location-based badges, activation sensors and smartphones.

In the system above, the management subsystem causes the trackable devices to provide users with improved awareness based upon at least one among: whether an asset being tracked is a person or an object; what is near, around, on, under or adjacent to the asset; who moved the asset; how the asset was moved; and whether the asset corresponds to a profile assigned thereto.

In the system above, the management subsystem comprises a controller that performs procedures to achieve location-based alarm management in accordance with the improved awareness provided to the users.

In the system above, the management subsystem further comprises one or more stations, which operatively cooperate with both the video surveillance subsystem and the positioning subsystem via the network connectivity, to provide information related to an alarm event that is subject to the location-based alarm management.

In the system above, the information related to the alarm event is based upon respective coverage areas of cameras within a certain region defined and mapped by specific location coordinates within a field of view for each camera, and based upon location coordinates from at least one trackable device that are routed to one or more appropriate cameras located within a defined field of view, relative to a location of the at least one trackable device, desired to be viewed by the users.

In the system above, the controller further performs dynamic routing of the alarm event such that either routing to a nearest station that supports provision of improved awareness to the users is performed, or routing to a different location is performed if routing to the nearest station is not possible.

In the system above, the video surveillance subsystem, the positioning subsystem, and the management subsystem are all configured to support Real-Time Location System (RTLS) technology and context-awareness technology.

In the system above, the trackable devices are configured to support Real-Time Location System (RTLS) technology.

In the system above, the video surveillance subsystem, the positioning subsystem, and the management subsystem are all configured to be implemented in the defined environment to handle staff duress situations.

Also, this disclosure provides an apparatus comprising: a memory having at least a set of instructions stored therein; and a processor, operatively connected with the memory, that performs processing to execute the set of instructions in providing enhanced awareness to users in a system environment that has a video surveillance platform comprising one or more cameras, and has an indoor location tracking platform that provides location information for a coverage area of the one more cameras, wherein the processor further performs processing to achieve location-based event management in accordance with the enhanced awareness obtained via at least one among a first scheme involving a combination of Real-Time Location System (RTLS) map technology, visual object detection technology and video analytics, and a second scheme based on RTLS software-driven camera orientation techniques.

In the apparatus above, the second scheme involves a combination of RTLS map related processing, field of view location processing and RTLS software-driven visual object detection technology.

In the apparatus above, the processor, in accordance with the video surveillance platform and the indoor location tracking platform, cooperates with asset tags that provide information about whether an asset is a person or an object, as well as location or movement characteristics of the asset.

In the apparatus above, field of view information for at least one of the cameras is mapped into a grid-like or coordinate-based format that allows a visual indication to be associated thereto.

In the apparatus above, the visual indication is displayed as a bounding box or a spatial indicator to indicate the location or movement of the asset tag, even if the asset tag is hidden or not in plain view of at least one of the cameras, and the user awareness is provided via at least one among visual confirmation, situational context, real-time status and historical insights.

In the apparatus above, the processor further performs selective transferring of event-related information for the location-based event management, either by transferring the event-related information to a nearest event processing location that supports provision of the enhanced awareness to the users or by transferring the event-related information to a different location if transferring to the nearest event processing location is not feasible.

Additionally, this disclosure provides a method comprising: processing positioning information from a positioning platform that detects at least one asset tag in a defined environment, the asset tag having an identifier that is compared with previously stored identification information in order to identify or obtain an estimated location of the asset tag; processing video surveillance information from a video surveillance platform having a plurality of cameras that obtain images or video related to the detected asset tag based on the estimated location of the asset tag, whereby field of view information for at least one of the cameras is mapped into a grid-like or coordinate-based format that allows a visual indication to be associated thereto; and performing, by a management platform operatively connected to both the video surveillance platform and the positioning platform via network connectivity, at least one among image processing and video analytics on the obtained images or video related to the detected asset tag to provide user awareness related to a location or movement of the asset tag in the defined environment.

In the method above, the visual indication is displayed as a bounding box or a spatial indicator to indicate the location or movement of the asset tag, even if the asset tag is hidden or not in plain view of at least one of the cameras, and the user awareness is provided via at least one among visual confirmation, situational context, real-time status and historical insights.

In the method above, the processing positioning information and the processing video surveillance information are performed by the management platform, and wherein the video surveillance subsystem, the positioning subsystem, and the management subsystem are all configured to support Real-Time Location System (RTLS) technology and context-awareness technology, which are implemented in the defined environment.

It will be appreciated by those skilled in the art that while the inventive features have been described above in connection with particular embodiments and examples, such inventive features are not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and aspects of the inventive concepts are set forth in the following claims.

What is claimed is:

1. A system comprising:
a positioning subsystem having one or more components that obtain positioning information about one or more trackable devices in a defined environment, which is monitored by a video surveillance subsystem having one or more cameras that obtain video surveillance information; and
a management subsystem that operatively cooperates with both the positioning subsystem and the video surveillance subsystem via network connectivity, and, based on the positioning information and the video surveillance information, provides users with improved awareness related to at least one among visual confirmation, situational context, real-time status and historical insights according to a location or movement of the trackable devices within and around the defined environment, when compared to a system that lacks the management subsystem cooperating with the positioning subsystem.

2. The system of claim 1, wherein the positioning subsystem supports at least one type of indoor positioning scheme that employs radio-frequency (RF) technologies and the one or more components are further configured to detect the trackable devices.

3. The system of claim 2, wherein the trackable devices comprise at least one among asset tags, tracking tags, location-based badges, activation sensors and smartphones.

4. The system of claim 3, wherein the management subsystem causes the trackable devices to provide users with improved awareness based upon at least one among: whether an asset being tracked is a person or an object; what is near, around, on, under or adjacent to the asset; who moved the asset; how the asset was moved; and whether the asset corresponds to a profile assigned thereto.

5. The system of claim 4, wherein the management subsystem comprises a controller that performs procedures to achieve location-based alarm management in accordance with the improved awareness provided to the users.

6. The system of claim 5, wherein the management subsystem further comprises one or more stations, which operatively cooperate with both the video surveillance subsystem and the positioning subsystem via the network connectivity, to provide information related to an alarm event that is subject to the location-based alarm management.

7. The system of claim 6, wherein the information related to the alarm event is based upon respective coverage areas of cameras within a certain region defined and mapped by specific location coordinates within a field of view for each camera, and based upon location coordinates from at least one trackable device that are routed to one or more appropriate cameras located within a defined field of view, relative to a location of the at least one trackable device, desired to be viewed by the users.

8. The system of claim 7, wherein the controller further performs dynamic routing of the alarm event such that either routing to a nearest station that supports provision of improved awareness to the users is performed, or routing to a different location is performed if routing to the nearest station is not possible.

9. The system of claim 8, wherein the video surveillance subsystem, the positioning subsystem, and the management subsystem are all configured to support Real-Time Location System (RTLS) technology and context-awareness technology.

10. The system of claim 9, wherein the trackable devices are configured to support Real-Time Location System (RTLS) technology.

11. The system of claim 10, wherein the video surveillance subsystem, the positioning subsystem, and the management subsystem are all configured to be implemented in the defined environment to handle staff duress situations.

12. An apparatus comprising:
a memory having at least a set of instructions stored therein; and
a processor, operatively connected with the memory, that performs processing to execute the set of instructions in providing enhanced awareness to users in a system environment that has a video surveillance platform comprising one or more cameras, and has an indoor location tracking platform that provides location information for a coverage area of the one more cameras,
wherein the processor further performs processing to achieve location-based event management in accordance with the enhanced awareness obtained via at least one among a first scheme involving a combination of Real-Time Location System (RTLS) map technology, visual object detection technology and video analytics, and a second scheme based on RTLS software-driven camera orientation techniques.

13. The apparatus of claim 12, wherein the second scheme involves a combination of RTLS map related processing, field of view location processing and RTLS software-driven visual object detection technology.

14. The apparatus of claim 13, wherein the processor, in accordance with the video surveillance platform and the indoor location tracking platform, cooperates with asset tags that provide information about whether an asset is a person or an object, as well as location or movement characteristics of the asset.

15. The apparatus of claim 12, wherein field of view information for at least one of the cameras is mapped into a grid-like or coordinate-based format that allows a visual indication to be associated thereto.

16. The apparatus of claim 15, wherein the visual indication is displayed as a bounding box or a spatial indicator to indicate the location or movement of the asset tag, even if the asset tag is hidden or not in plain view of at least one of the cameras, and the user awareness is provided via at least one among visual confirmation, situational context, real-time status and historical insights.

17. The apparatus of claim 14, wherein the processor further performs selective transferring of event-related information for the location-based event management, either by transferring the event-related information to a nearest event processing location that supports provision of the enhanced awareness to the users or by transferring the event-related information to a different location if transferring to the nearest event processing location is not feasible.

18. A method comprising:
processing positioning information from a positioning platform that detects at least one asset tag in a defined environment, the asset tag having an identifier that is compared with previously stored identification information in order to identify or obtain an estimated location of the asset tag;
processing video surveillance information from a video surveillance platform having a plurality of cameras that obtain images or video related to the detected asset tag based on the estimated location of the asset tag, whereby field of view information for at least one of the cameras is mapped into a grid-like or coordinate-based format that allows a visual indication to be associated thereto; and
performing, by a management platform operatively connected to both the video surveillance platform and the positioning platform via network connectivity, at least one among image processing and video analytics on the obtained images or video related to the detected asset tag to provide user awareness related to a location or movement of the asset tag in the defined environment.

19. The method of claim 18, wherein the visual indication is displayed as a bounding box or a spatial indicator to indicate the location or movement of the asset tag, even if the asset tag is hidden or not in plain view of at least one of the cameras, and the user awareness is provided via at least one among visual confirmation, situational context, real-time status and historical insights.

20. The method of claim 19, wherein the processing positioning information and the processing video surveillance information are performed by the management platform, and wherein the video surveillance subsystem, the positioning subsystem, and the management subsystem are all configured to support Real-Time Location System (RTLS) technology and context-awareness technology, which are implemented in the defined environment.
